(19) United States
(12) Patent Application Publication
(10) Pub. No.: US 2006/0228050 A1
(43) Pub. Date: Oct. 12, 2006

(54) Method for calibrating 3d image sensors

(75) Inventors: Zhanping Xu, Siegen (DE); Christian Lang, Laufen (DE); Bernd Schneider, Baltmannsweiler (DE)

Correspondence Address: FASSE PATENT ATTORNEYS, P.A., P.O. BOX 726, HAMPDEN, ME, 04444-0726, US

(73) Assignee: Conti Temic Microelectronic GmbM, Nuernberg (DE)

(21) Appl. No.: 10/539,892

(22) PCT Filed: Dec. 18, 2003
(86) PCT No.: PCT/DE03/04182

§ 371 Date: Jun. 17, 2005

(30) Foreign Application Priority Data
Dec. 18, 2002 (DE) 102 59 135.0

(51) Int. Cl. G06K 9/20; G02B 7/04

(52) U.S. Cl. 382/317; 250/201.2; 250/201.1; 356/456

(57) ABSTRACT

The invention relates to a method for calibrating 3D image sensors. Work tolerances, temperature variations and aging processes result in that the various pixels in a receiving array deviate from one another to different degrees. The aim of the invention is therefore to calibrate the entire receiving array with respect to every pixel. During operation of the 3D image sensor there is usually no reference scene available with which every pixel could be calibrated based on known phase relations. According to the invention, the entire receiving array is illuminated at defined intervals exclusively with one modulated light source. Alternatively, the emitted light source can be used via a deflection device. Two different distances can be simulated by carrying out two calibrating measurements with different phase relations between emitted and received signal, thereby making it possible to detect distance-related errors for every pixel individually.

The invention relates to a method for calibrating 3D image sensors according to the preamble of patent claim 1.

3D image sensors used for measuring distances according to the incoherent optical transit-time method (modulation interferometry method) are known from DE 198 21 974 A I, for example.

When measuring distances according to said optical transit-time method, the following mixed process has to be carried out:

The amplitude-modulated illuminating light reflected by the scene to be measured is demodulated (correlated) with a demodulation signal, for example an identical signal, thereby determining the phase relation (correlation) between the emitted signal and the received signal. This phase relation is used as a measure of the distance covered by the emitted light.

For obtaining a complete 3D image, the scene has to be sensed by means of a 2D receiving array, wherein each individual pixel carries out the mixed process described above. Work tolerances, temperature variations, and aging processes may result in that the individual pixels in the receiving array deviate from one another with respect to their function. If these deviations become too great, the receiving array has to be referenced.

From DE 101 26 086 A1 an optoelectronic sensor is known, wherein, for referencing the light, the emitting element used for illuminating the scene or a separate emitting element emits towards a reference object within the sensor and the reference object detects the received signal as a reference signal by means of a separate receiver or the receiver provided for receiving reflections from the scene whereafter aging and temperature effects are derived from said reference signal. By amplitude modulation at the emitter and by means of a phase comparator at the receiver, distance information is derived with this sensor, too.

From DE 196 43 287 A1 a method and an arrangement are known for minimizing the following problems occurring with the optical transit-time method with an image sensor and active illumination:

a) temperature-dependent phase shift of the receiving array

b) temperature drifts in the emitting element (LED or laser diode)

This known method proposes referencing the emitted signal to a specific reference pixel in the receiving array, wherein said reference pixel during each measuring exclusively receives a reference signal covering a predetermined distance. Since the transit time of the reference signal is known, the various drift effects changing from time to time on account of varying system conditions can be compensated.

Work tolerances (for example fixed pattern noise), temperature variations, and aging processes result in that the characteristics of the various pixels in a receiving array deviate from one another to different degrees. If these deviations become too great, the entire receiving array has to be calibrated with respect to every pixel, which cannot be done by use of the method mentioned above. On the other hand, during operation of the 3D image sensor there is usually no reference scene available with which every pixel could be calibrated based on known phase relations.

The object of the invention is to provide a method for referencing 3D image sensors making the calibration of the receiving array during operation possible.

This object is achieved by a method with the features of the relevant independent claims. The invention is advantageously realized according to the features of the dependent claims.

The invention enables the distance-related pixel-individual differences to be detected and to be compensated by suitable means. For this purpose, the receiving array is illuminated with a modulated light source (for example LED, laser diode, etc.) exclusively emitting a calibrating radiation with a phase position, which is at least largely homogenous for all pixels with respect to the demodulation signal. This may be achieved by direct or deflected illumination with a modulated light source, wherein the distance to all pixels is approximately identical.

The occurring received signals of the individual pixels are evaluated for every pixel individually, thereby detecting deviations, disturbances or defects of individual pixels. Only in this manner, the pixel-individual deviations can be compensated, said compensation being extremely important with respect to the detecting and tracking of objects in moving systems.

In particular, it is also possible to detect the relative phase deviation between the pixels in addition to or instead of comparing an absolute value with a desired value, thereby normalizing the signals of the pixels with respect to a reference quantity.

In this connection, the phase relation between the emitted signal and the demodulation signal is preferably changed which change corresponds to measuring with a virtual second distance (i.e. calibrating to at least two virtual distances). The phase position is preferably brought about by correspondingly delaying the emitted signal or the demodulation signal relative to the respective other signal so that the actual distance between the light source and the receiving array is not changed.

In this manner it is possible (in particular independent of the actual absolute phase relation) to assess the pixel-individual deviations relative to one another for each calibrating measurement on the basis of the known phase shift between the at least two calibrating measurements.

Preferably, the phase relation is freely selectable. For example, it is adjusted along a predetermined characteristic for the respective number of emitting processes. In this manner, nonlinearities can be detected for every pixel individually depending on the distance of subsequent target objects, thereby making referencing with different virtual distances possible.

In one exemplary embodiment of the invention, the 3D image sensor according to the invention comprises a reference light source, which is provided in addition to the usually existing elements and can be modulated like the light source of the emitting unit. The reference light source is arranged such that the light illuminating the entire receiving array is characterized by a phase position which is at least largely homogenous for all pixels with respect to the demodulation signal and preferably by an approximately homogenous brightness, i.e. the illumination is direct without the use of reference objects or the like. The receiving array functioning optimally, every pixel should measure the distance or phase shift predetermined by the reference distance and the set phase position between the reference light source and the demodulation signal.

If individual pixels differ from the desired value or from one another on account of work tolerances, temperature variations, and aging processes, these deviations are recorded in a look-up table for every pixel individually, for example. Thanks to the phase shift it is also possible to detect nonlinearities or disturbances in particular distance ranges and to record them in a matrix or in families of characteristics, for example. In addition to that, interpolations between two data points are conceivable.

In a second embodiment of the invention, the entire receiving array is calibrated by deflecting the illuminating light of the emitting unit such that an internal connection between the emitter and the receiving array is established. At the same time, the external connection for illuminating the scene is interrupted in this case so that no emitted light incident from an unknown scene and thus comprising an unknown phase shift can illuminate the pixels. During the measurement of distances it is guaranteed that the internal connection is interrupted again so that the phase measurement is not disturbed. These closing apparatuses are formed as one or more mechanical change-over switches, for example. In practice, however, one tries to use as few movable components as possible. Also in this case, the phase relation between the modulated emitted signal and the received signal is varied for making calibration with different phase positions (virtual distances) possible.

One disadvantage of conventional reference measuring where a known scene has to be sensed consists in that such a scene is not always available (if the reference scene is hidden, for example). The invention described above avoids this problem. Another advantage of the referencing method according to the invention is the possibility of referencing within the entire temperature range of the 3D image sensor without having to remove the sensor from its place of installation. The same thing refers to age-related drifts.

1. Method for calibrating 3D image sensors, said sensors comprising:
a light source emitting a modulated emitted signal into the viewed scene; and
a receiving array consisting of a plurality of pixels, said pixels generating a received signal for every pixel individually from a demodulation signal comprising a predetermined phase position with respect to the emitted signal and from the detected radiation reflected by the scene, said received signal being used as a measure of distance;
characterized in that
for the purpose of calibration, the entire receiving array is exclusively illuminated with a calibrating radiation comprising a phase position which is at least largely homogenous for all pixels with respect to the demodulation signal and that the occurring received signals of the individual pixels are evaluated.

2. Method according to claim 1, characterized in that the relative phase deviation between the pixels is detected.

3-9. (canceled)

10. Method according to claim 1, characterized in that at least a second measurement is carried out with a calibrating radiation comprising a second phase position between the calibrating radiation and the demodulation signal, said second phase position differing from the first phase position.

11. Method according to claim 10, characterized in that the phase relation is freely selectable and preferably adjusted along a predetermined characteristic for the respective number of emitting processes.

12. Method according to claim 1, characterized in that the calibrating radiation is generated by a further light source exclusively illuminating the entire receiving array at defined intervals.

13. Method according to claim 1, characterized in that the calibrating radiation is generated by the already existing light source, wherein the radiation is deflected from the light source to the receiving array and the external connection for illuminating the scene is interrupted.

14. Method according to claim 1, characterized in that the pixel-individual phase deviation detected at the defined intervals is recorded in a look-up table for every pixel individually for correcting the 3D image information of the viewed scenes.

15. Use of the method according to claim 1, for 3D image sensors for sensing the environment and the passenger compartment of motor vehicles, in particular for obstacle and/or traffic lane recognition with a motor vehicle and/or for seat occupancy recognition.

16. Use of the method according to claim 1, for 3D image sensors for sensing in connection with industrial facilities.
